(19) United States
(12) Patent Application Publication
(10) Pub. No.: US 2026/0184104 A1
(43) Pub. Date: Jul. 2, 2026

(54) DRIVE AXLE ASSEMBLY

(71) Applicant: HYUNDAI WIA CORPORATION, Changwon-si (KR)

(72) Inventors: Chang Hee JEONG, Uiwang-si (KR); Soo Kyoung LEE, Uiwang-si (KR); Yun Ho JUNG, Uiwang-si (KR); Hong Kyu CHOI, Uiwang-si (KR)

(21) Appl. No.: 19/433,221

(22) Filed: Dec. 26, 2025

(30) Foreign Application Priority Data
Dec. 31, 2024 (KR) 10-2024-0202166

(51) Int. Cl. B60B 27/00

(52) U.S. Cl. CPC B60B 27/0073; B60B 27/0005

(57) ABSTRACT

There is disclosed a drive axle assembly comprising a wheel hub; a wheel bearing assembled to the wheel hub and comprising an outer ring, an inner ring, and balls interposed between the outer ring and the inner ring; a sealing portion disposed between the outer ring and the inner ring and configured to seal the space where the balls are positioned; and a dust ring installed on the inner ring so as to face the outer end of the sealing portion.

This application claims priority to and the benefit of Korean Patent Application No. 10-2024-0202166, filed on 2024.12.31, the disclosure of which is incorporated herein by reference in its entirety.

### BACKGROUND

### Technical Field

The present disclosure relate to a drive axle assembly, more particularly, a drive axle assembly that may enhance sealing performance to prevent moisture and other foreign substances from entering the internal space of a wheel bearing through a dust rings, thereby reducing the drag torque of the sealing portion.

### Background of the Disclosure

In the wheel bearings of integrated drive axles, the encoder seal serves as a target for sensors measuring the vehicle's speed and prevents foreign matter from entering the wheel bearing.

Conventional methods for enhancing sealing performance include modifying an encoder seal structure or increasing the interference between each lip in the encoder seal, as disclosed in Korean Patent Publication No. 2020-0021592. However, increasing the overall interference of the encoder seal leads to an increase in drag torque of the encoder seal. In other words, reducing drag torque of the encoder seal requires a compromise in sealing performance, and a device capable of compensating for this is necessary.

### SUMMARY

Accordingly, one object of the present disclosure is to provide a drive axle assembly that may enhance sealing performance to prevent moisture and other foreign substances from entering the internal space of the wheel bearing through a dust ring, thereby reducing the drag torque of the sealing portion.

The objects of the present disclosure are not limited to those mentioned above, and other technical objects may be inferred from following embodiments.

To solve the objects of the present disclosure, according to an embodiment of the present disclosure, a drive axle assembly may include a wheel hub; a wheel bearing assembled to the wheel hub and comprising an outer ring, an inner ring, and balls interposed between the outer ring and the inner ring; a sealing portion disposed between the outer ring and the inner ring and configured to seal the space where the balls are positioned; and a dust ring installed on the inner ring so as to face the outer end of the sealing portion.

According to the embodiments, the dust ring may be pressedly inserted into the inner ring.

According to the embodiments, the dust ring may be formed in a circular ring shape surrounding the inner ring.

According to the embodiments, the dust ring may include a first ring portion configured to contact the inner ring, and a second ring portion configured to extend in a bent state from the first ring portion and face the outer end of the sealing portion.

According to the embodiments, the second ring portion may extend beyond an upper portion of the sealing portion and may be positioned higher than the sealing portion.

According to the embodiments, the first ring portion may not cover a boot assembly portion formed on the inner ring and on which a boot is assembled.

According to the embodiments, the outer ring may include a protrusion configured to protrude so that the second ring portion is positioned radially inward thereof.

According to the embodiments, the drive axle assembly may further include an encoder installed on the dust ring.

According to the embodiments, the encoder may be installed at an end of the second ring portion positioned far from the first ring portion.

According to the embodiments, the protrusion may protrude 0.2 mm or more than the encoder.

According to the embodiments, a gap may be formed between the outer end of the sealing portion and the second ring portion.

According to the embodiments, the gap may have a length of 1 mm or more.

According to the embodiments, the second ring portion may include one or more discharge holes configured to discharge foreign substances introduced into the gap.

According to the embodiments, the discharge holes may be formed in plurality, and the plurality of discharge holes may be spaced apart along a circumferential direction of the second ring portion.

According to the embodiments, a boot assembly portion on which a boot may be assembled is formed in the first ring portion.

According to the embodiments, the second ring portion may extend beyond the outer ring, and the dust ring may further include a third ring portion configured to extend in a bent state from the second ring portion and contact a radially outer surface of the outer ring.

According to the embodiments, an orbital forming portion having a shape rolled outward toward the inner ring may be formed at one end of the wheel hub, and the first ring portion may include an extension portion configured to extend beyond the inner ring and the orbital forming portion, and a boot assembly portion on which a boot is assembled may be formed in the extension portion.

According to the present disclosure, as the dust ring is installed on the inner ring so as to face the outer end of the sealing portion, the dust ring may surround the sealing portion from the outside, thereby preventing foreign substances such as moisture from entering the internal space of the wheel bearing.

Furthermore, if a gap is formed between the outer end of the sealing portion and the dust ring, and a discharge hole is formed in the dust ring to allow foreign matter entering through the gap to be discharged, even if foreign matter enters the gap, it may be discharged back to the outside through the discharge hole without entering the sealing portion. Ultimately, this may enhance the sealing performance of the wheel bearing.

Since the sealing performance is enhanced by the dust ring, the amount of interference in the sealing portion may be reduced, thereby reducing drag torque.

Furthermore, if the outer ring includes a protrusion, the second ring of the dust ring and the encoder may be positioned radially inward of the protrusion, providing protection from the outside. In particular, this may prevent the dust ring and encoder from colliding with the knuckle during assembly of the outer ring and knuckle.

Furthermore, if the boot assembly is integrated into the dust ring, weight may be reduced.

It should be understood that the detailed description and specific examples, while indicating preferred embodiments of the disclosure, are given by illustration only, since various changes and modifications within the spirit and scope of the disclosure will become apparent to those skilled in the art from this detailed description.

### DESCRIPTION OF DRAWINGS

FIG. 1 is a cross-sectional view illustrating a drive axle assembly according to a first embodiment of the present disclosure;

FIG. 2 is an enlarged cross-sectional view of A shown in FIG. 1, omitting the boot and sensor;

FIG. 3 is a perspective view of FIG. 1, omitting the boot and sensor;

FIG. 4 is a side view of FIG. 3;

FIG. 5 is a cross-sectional view illustrating a drive axle assembly according to a second embodiment of the present disclosure;

FIG. 6 is a cross-sectional view illustrating a drive axle assembly according to a third embodiment of the present disclosure; and

FIG. 7 is a cross-sectional view illustrating a drive axle assembly according to a fourth embodiment of the present disclosure.

### DESCRIPTION OF SPECIFIC EMBODIMENTS

Hereinafter, a preferred embodiment of a two-speed transfer case having a single actuator of the present disclosure will be described with reference to the attached drawings.

In addition, the terminology used herein is for the purpose of describing embodiments only and is not intended to be limiting of the present disclosure. In this specification, the singular also includes the plural unless the context clearly dictates otherwise.

In order to clearly explain the present disclosure, parts irrelevant to the description have been omitted, and the same reference numerals are used for identical or similar components throughout the specification. Throughout the specification, when a part is said to “comprise” "include" a certain component, this does not mean that other components are excluded, but rather that other components may be additionally included, unless specifically stated otherwise.

In addition, components expressed as “part”, “unit” and “portions” throughout the disclosure may be two or more components combined into one component, or one component may be divided into two or more components with more detailed functions. In addition, each component described below may additionally perform some or all of the functions performed by other components in addition to its own main function, and of course, some of the main functions performed by each component may be performed exclusively by other components.

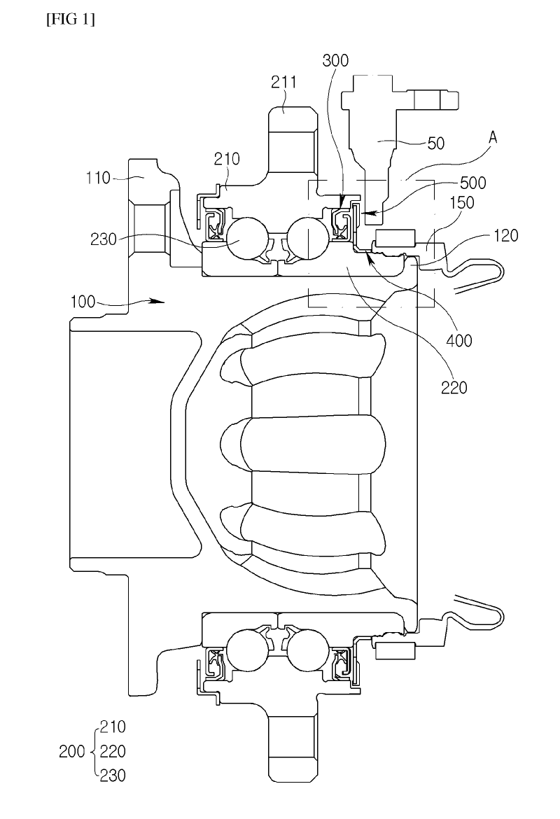

First, referring to FIGS. 1 to 4, a drive axle assembly according to a first embodiment of the present disclosure will be described.

The drive axle assembly of the present disclosure may include a wheel hub 100, a wheel bearing 200, a sealing portion300, a dust ring 400, and an encoder 500.

The wheel hub 100 may be formed as a generally cylindrical structure extending axially, and a hub flange 110 may be provided on one outer peripheral surface of the wheel hub 100. The hub flange 110 extends radially outward from the outer peripheral surface of the wheel hub 100 and is used to mount a vehicle's brake disc and wheel to the wheel hub 100 using hub bolts or the like.

The wheel hub 100 forms a receiving space at the end on the body side so that the rolling member and inner race of the constant velocity joint may be inserted into and combined with the wheel hub 100. That is, since the wheel hub 100 supports the rolling member of the constant velocity joint from the outside, the wheel hub 100 may also function as the outer race of the constant velocity joint.

The wheel bearing 200 is assembled to the wheel hub 100 and includes an outer ring 210, an inner ring 220, and a ball 230 interposed between the outer ring 210 and the inner ring 220. In this embodiment, it has been described that all of the balls 230 are interposed between the outer ring 210 and the inner ring 220. However, in some cases, some of the balls 230 may be interposed between the outer ring 210 and the wheel hub 100.

Specifically, the inner ring 220 is arranged on the outer surface of the wheel hub 100. At this time, an orbital forming portion 120 is formed at one end of the wheel hub 100 in a shape that is rolled outward toward the inner ring 220, and the inner ring 220 is fixed by the orbital forming portion 120. The orbital forming portion 120 may be formed by plastically deforming one end of the wheel hub 100. The inner ring 220 has a raceway surface for the ball 230 formed on the outer surface thereof, such that the inner ring 220 supports the ball 230 radially inwardly.

The outer ring 210 is positioned radially outwardly of the inner ring 220 and includes an outer ring flange 211 used to mount the wheel bearing 200 to the knuckle of the vehicle body. The outer ring 210 has a raceway surface for the ball 230 formed on the inner surface thereof, such that the outer ring 210 supports the ball 230 radially outwardly.

The ball 230 is interposed between the inner ring 220, which is a rotating element of the wheel bearing 200, and the outer ring 210, which is a non-rotating element, and may perform the function of supporting the rotating element so that it may rotate relative to the non-rotating element.

A sealing portion 300 is arranged between the outer ring 210 and the inner ring 220, sealing the space where the balls 230 are arranged. The structure and shape of the sealing portion 300 may be formed in various ways. In the present embodiment, two inner rings 220 and two balls 230 are arranged along the axial direction, so two sealing portions 300 are arranged between the outer ring 210 and the inner ring 220 arranged on the left side of the drawing, and between the outer ring 210 and the inner ring 220 arranged on the right side of the drawing.

The dust ring 400) is installed on the inner ring 220 so as to face the outer end of the sealing portion 300. In this embodiment, the dust ring 400 is installed on the inner ring 220 located on the right side of the drawing so as to face the outer end of the sealing portion 300 located on the right side of the drawing.

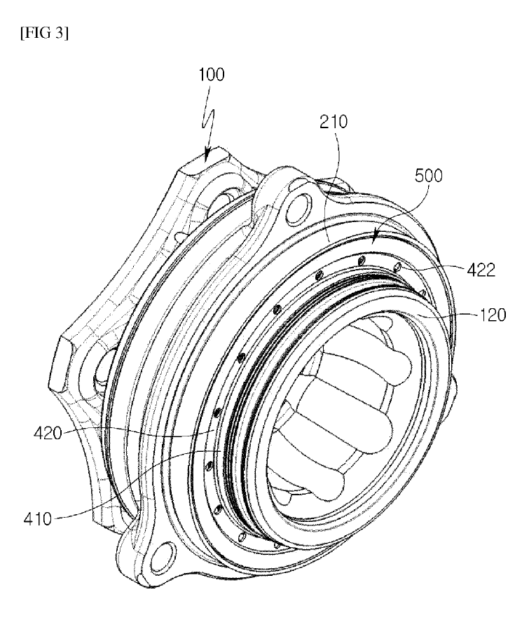

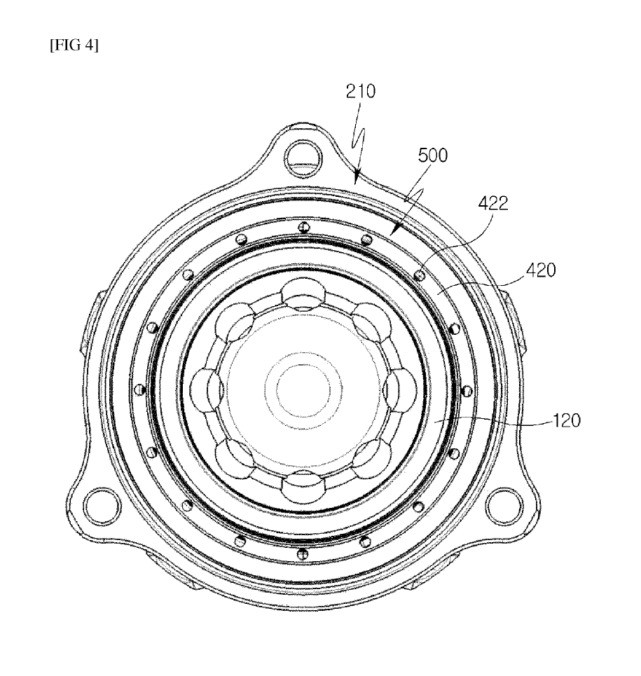

As illustrated in FIGS. 3 and 4 , the dust ring 400 is formed in a circular ring shape surrounding the inner ring 220, and it is preferable that the dust ring 400 be installed by being press-fitted into the inner ring 220. However, embodiments are not limited thereto, and the dust ring 400 may also be installed on the inner ring 220 using a separate fixing member or adhesive.

In the present embodiment, the dust ring 400 has an L-shaped cross-section. Specifically, the dust ring 400 includes a first ring portion 410 that contacts the inner ring 220, and a second ring portion 420 that extends in a bent state from the first ring portion 410 and faces the outer end of the sealing portion 300.

The first ring portion 410 extends axially and contacts the outer surface of the inner ring 220. In the present embodiment, the boot assembly portion 221, on which the boot 150 is assembled, is formed on the inner ring 220. Therefore, the first ring portion 410 extends only from the portion of the inner ring 220 where the boot assembly portion 221 is not formed, so as not to cover the boot assembly portion 221. The boot 150 is connected to the boot assembly 221 via a band or the like to seal the receiving space of the wheel hub 100.

The second ring portion 420 extends radially from the first ring portion 410 at an approximately 90° angle, extending at least to the upper end of the sealing portion 300 so as to face the entire height of the sealing portion 300. Preferably, the second ring portion 420 extends beyond the upper end of the sealing portion 300 and is positioned higher than the sealing portion 300.

In this way, the dust ring 400 surrounds the sealing portion 300 from the outside, blocking the entrance of the sealing portion 300, thereby preventing moisture and other foreign substances from entering the internal space of the wheel bearing 200.

In the present disclosure, the encoder 500 is installed in the dust ring 400 rather than the sealing portion 300. A separate sensor 50 may detect the rotational speed of the axle according to the rotation of the inner ring 220 by detecting the encoder 500. In this case, the size of the encoder 500 may be further increased when it is installed in the dust ring 400 compared to when it is installed in the sealing portion 300, so that the encoder mounting diameter may be increased, making it easy to increase the number of poles, and thereby enabling precise control of the autonomous vehicle.

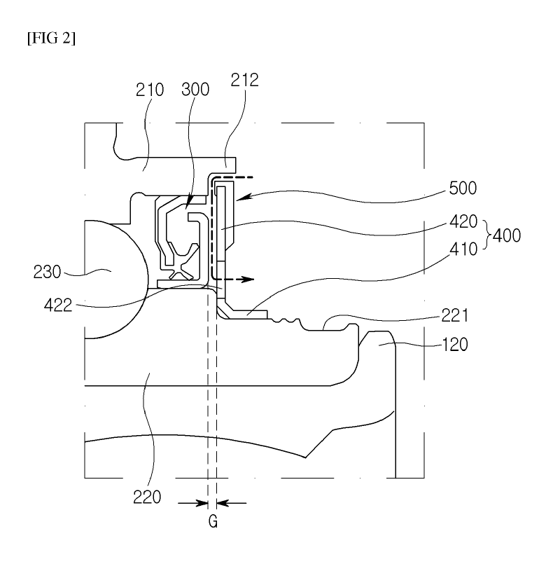

Specifically, the encoder 500 may be installed at the end of the second ring portion 420 located farther from the first ring portion 410. FIG. 2 illustrates that the encoder 500 is fitted to surround the end of the second ring portion 420.

In the present embodiment, the outer ring 210 includes a protrusion 212 that protrudes so that the second ring portion 420 and the encoder 500 are positioned radially inward thereof. That is, the protrusion 212 surrounds the second ring portion 420 and the encoder 500 from the radially outer side. This allows the dust ring 400, particularly the second ring portion 420 and the encoder 500, to be protected from the outside by the protrusion 212 of the outer ring. In particular, even if the outer ring 210 and the knuckle are eccentrically assembled, the dust ring 400 and encoder 500 may be prevented from colliding with the knuckle, thereby preventing deformation (crushing) of the dust ring 400. It is preferable that the protrusion 212 protrude at least 0.2 mm and no more than 3 mm further than the encoder 500.

In the present embodiment, a gap (G) is formed between the outer end of the sealing portion 300 and the second ring portion 420. Although not limited thereto, the gap (G) is preferably 1 mm or more and no more than 3 mm in length. This ensures that even if moisture or other foreign matter enters between the outer ring 210 and the encoder 500, it will not enter the sealing portion 300 but will remain within the gap (G).

Furthermore, since the protrusion 212 of the outer ring prevents foreign substances from directly entering the gap (G), the two-stage structure may delay the inflow of foreign substances.

In addition, the second ring portion 420 is provided with one or more discharge holes 422 so that foreign substances entering the gap (G) may be discharged. As illustrated in FIGS. 3 and 4 , in the present embodiment, the plurality of discharge holes 422 are formed, and the plurality of discharge holes 422 are spaced apart along the circumference of the second ring portion 420. In the present embodiment, sixteen discharge holes 422 are spaced apart at equal intervals along the circumference of the second ring portion 420, but the number and arrangement of the discharge holes 422 may vary.

In this way, even if foreign substances enter through the gap (G), they do not enter the sealing portion 300 but are discharged back to the outside through the discharge holes 422 (see arrow in FIG. 2), ultimately enhancing the sealing performance of the wheel bearing 200. Since the sealing performance is enhanced by the dust ring 400, the interference of the sealing portion 300 may be reduced, thereby lowering drag torque.

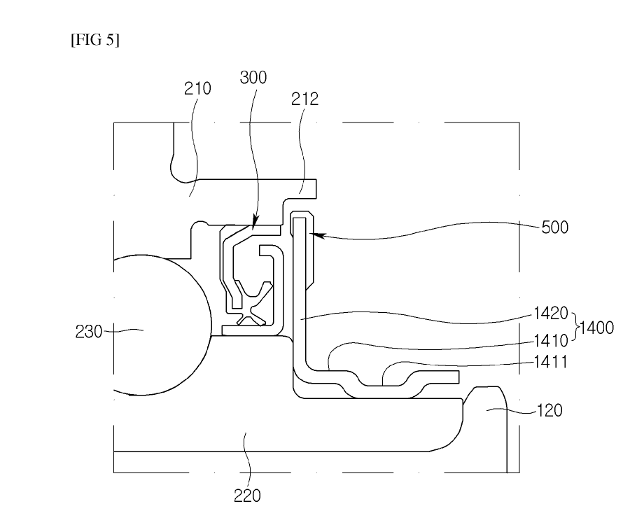

Next, a drive axle assembly according to a second embodiment of the present disclosure will be examined with reference to FIG. 5.

The drive axle assembly of the present embodiment includes a wheel hub 100, a wheel bearing 200, a sealing portion 300, and an encoder 500 similar to the drive axle assembly illustrated in FIG. 1, but differs in some aspects from the structure of a dust ring 1400. Below, the structure of the different dust ring 1400 will be examined in detail.

The arrangement and overall L-shaped cross-sectional shape of the dust ring 1400 are similar to those of the dust ring 400 illustrated in FIG. 2, and similarly includes a first ring portion 1410 that contacts the inner ring 220, and a second ring portion 1420 that extends in a bent state from the first ring portion 1410 and faces the outer end of the sealing portion 300. Although FIG. 5 depicts a cross-section in which the discharge hole is not visible in the second ring portion 1420, as described above, a discharge hole may be formed in the second ring portion 1420 to discharge foreign substances entering the gap.

However, in the present embodiment, the boot assembly portion 1411, on which the boot 150 is assembled, is not formed in the inner ring 220, but in the first ring portion 1410. That is, the first ring portion 1410 extends along the inner ring 220 to the orbital forming portion 120, and the boot assembly portion 1411 is formed on the extended first ring portion 1410. When the boot assembly portion 1411 is formed integrally with the dust ring 1400 in this manner, the outer diameter of the inner ring 220 may be reduced, thereby reducing weight.

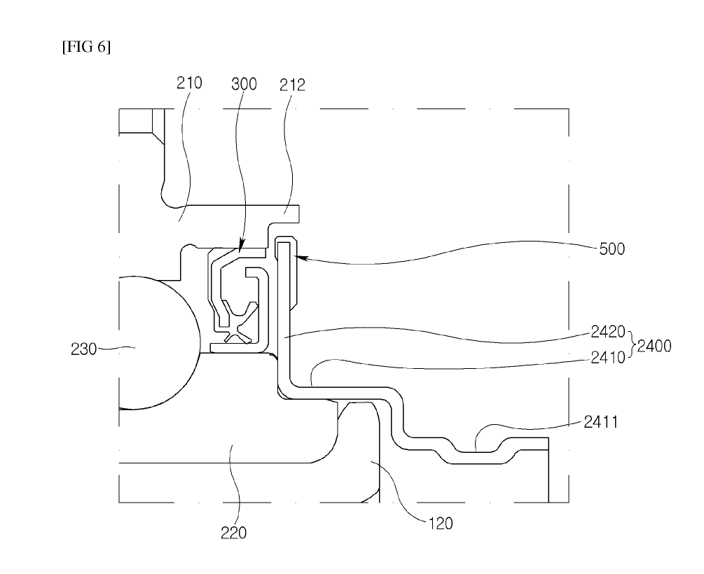

Next, with reference to FIG. 6, a drive axle assembly according to a third embodiment of the present disclosure will be examined.

The drive axle assembly of this embodiment includes the wheel hub 100, a wheel bearing 200, a sealing portion 300, and an encoder 500 similar to the drive axle assembly illustrated in FIG. 1, but differs in the structure of a dust ring 2400. Below, the structure of the different dust ring 2400 will be examined in detail.

The arrangement and overall L-shaped cross-sectional shape of the dust ring 2400 are similar to those of the dust ring 400 illustrated in FIG. 2, and similarly includes a first ring portion 2410 that contacts the inner ring 220 and a second ring portion 2420 that extends in a bent state from the first ring portion 2410 and faces the outer end of the sealing portion300. Although FIG. 6 depicts a cross-section in which the discharge hole is not visible in the second ring portion 2420, as described above, a discharge hole may be formed in the second ring portion 2420 to discharge foreign substances that have entered the gap.

However, in the present embodiment, the boot assembly portion 2411 on which the boot 150 is assembled is not formed in the inner ring 220, but in the first ring portion 2410.

In addition, the first ring portion 2410 includes an extension portion that extends beyond the inner ring 220 and the orbital forming portion 120, and the boot assembly portion 2411 is formed on the extension portion of the first ring portion 2410. That is, in FIGS. 2 and 5, the boot assembly portions 221, 1411 are positioned above the inner ring 220, but in the present embodiment, the boot assembly portion 2411 is not positioned above the inner ring 220, but is positioned in the air beyond the orbital forming portion 120. In this case, since the boot assembly portion 2411 is formed integrally with the dust ring 2400, not only may the outer diameter of the inner ring 220 be reduced, but also the length of the inner ring 220 may be shortened, so that the weight may be further reduced.

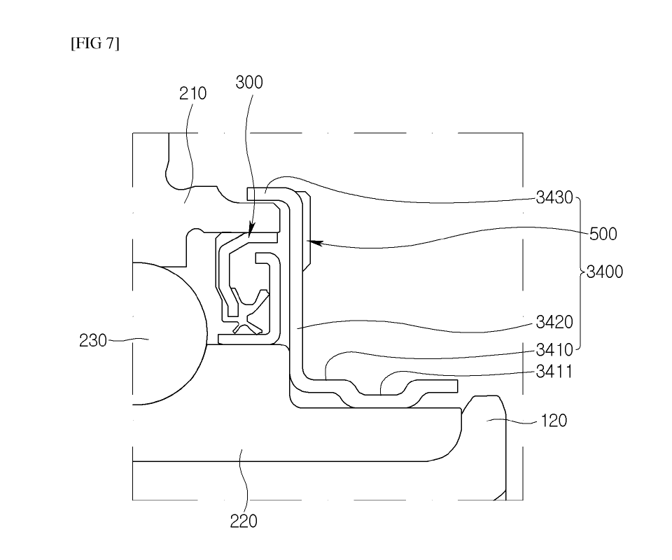

Finally, with reference to FIG. 7, a drive axle assembly according to a fourth embodiment of the present disclosure will be examined.

The drive axle assembly of this embodiment includes the wheel hub 100, wheel bearing 200, sealing portion 300, and encoder 500 similar to the drive axle assembly illustrated in FIG. 1, but differs in the structure of a dust ring 3400. Below, we will focus on the structure of the different dust ring 3400.

The arrangement and overall L-shaped cross-sectional shape of the dust ring 3400 are similar to those of the dust ring 400 illustrated in FIG. 2. Similarly, the dust ring 3400 includes a first ring portion 3410 that contacts the inner ring 220, and a second ring portion 3420 that extends in a bent state from the first ring portion 3410 and faces the outer end of the sealing portion 300. Although FIG. 7 depicts a cross-section in which the second ring portion 3420 does not have a visible discharge hole, as described above, the second ring portion 3420 may of course have a discharge hole formed therein to discharge foreign substances entering the gap.

However, in the present embodiment, the second ring portion 3420 extends radially outward beyond the outer ring 210, so that the outer ring 210 does not include a protrusion 212. Furthermore, the dust ring 3400 further includes a third ring portion 3430 that extends in a bent state from the second ring portion 3420 and contacts the radially outer surface of the outer ring 210. When the dust ring 3400 is configured to wrap around the outer ring 210, sealing performance may be maximized.

In addition, as seen in FIG. 5, the boot assembly portion 3411 on which the boot 150 is assembled is not formed on the inner ring 220, but on the first ring portion 3410. In this way, when the boot assembly portion 3411 is formed integrally with the dust ring 3400, the outer diameter of the inner ring 220 may be reduced, so the weight may be reduced.

Although the present disclosure has been described with reference to the exemplified drawings, it is to be understood that the present disclosure is not limited to the embodiments and drawings disclosed in this specification, and those skilled in the art will appreciate that various modifications are possible without departing from the scope and spirit of the present disclosure. Further, although the operating effects according to the configuration of the present disclosure are not explicitly described while describing an embodiment of the present disclosure, it should be appreciated that predictable effects are also to be recognized by the configuration.

### Numeral references

50: Sensor

100: Wheel hub

110: Hub flange

120: Orbital forming portion

150: Boot

200: Wheel bearing

210: Outer ring

211: Outer ring flange

212: Protrusion

220: Inner ring

221: Boot assembly portion

230: Ball

300: Sealing portion

400, 1400, 2400, 3400: Dust ring

410, 1410, 2410, 3410: First ring portion

420, 1420, 2420, 3420: Second ring portion

422: Discharge hole

500: Encoder

1411, 2411, 3411: Boot assembly portion

3430: Third ring portion

G: Gap

1. A drive axle assembly comprising:
a wheel hub;
a wheel bearing assembled to the wheel hub and comprising an outer ring, an inner ring, and balls interposed between the outer ring and the inner ring;
a sealing portion disposed between the outer ring and the inner ring and configured to seal the space where the balls are positioned; and
a dust ring installed on the inner ring so as to face the outer end of the sealing portion.

2. The drive axle assembly of claim 1, wherein the dust ring is pressedly inserted into the inner ring.

3. The drive axle assembly of claim 2, wherein the dust ring is formed in a circular ring shape surrounding the inner ring.

4. The drive axle assembly of claim 1, wherein the dust ring comprises a first ring portion configured to contact the inner ring, and a second ring portion configured to extend in a bent state from the first ring portion and face the outer end of the sealing portion.

5. The drive axle assembly of claim 4, wherein the second ring portion extends beyond an upper portion of the sealing portion and is positioned higher than the sealing portion.

6. The drive axle assembly of claim 4, wherein the first ring portion does not cover a boot assembly portion formed on the inner ring and on which a boot is assembled.

7. The drive axle assembly of claim 4, wherein the outer ring comprises a protrusion configured to protrude so that the second ring portion is positioned radially inward thereof.

8. The drive axle assembly of claim 7, further comprising:
an encoder installed on the dust ring.

9. The drive axle assembly of claim 8, wherein the encoder is installed at an end of the second ring portion positioned far from the first ring portion.

10. The drive axle assembly of claim 9, wherein the protrusion protrudes 0.2 mm or more than the encoder.

11. The drive axle assembly of claim 4, wherein a gap is formed between the outer end of the sealing portion and the second ring portion.

12. The drive axle assembly of claim 11, wherein the gap has a length of 1 mm or more.

13. The drive axle assembly of claim 11, wherein the second ring portion comprises one or more discharge holes configured to discharge foreign substances introduced into the gap.

14. The drive axle assembly of claim 13, wherein the discharge holes are formed in plurality, and the plurality of discharge holes are spaced apart along a circumferential direction of the second ring portion.

15. The drive axle assembly of claim 4, wherein a boot assembly portion on which a boot is assembled is formed in the first ring portion.

16. The drive axle assembly of claim 4, wherein the second ring portion extends beyond the outer ring, and
the dust ring further comprises a third ring portion configured to extend in a bent state from the second ring portion and contact a radially outer surface of the outer ring.

17. The drive axle assembly of claim 4, wherein an orbital forming portion having a shape rolled outward toward the inner ring is formed at one end of the wheel hub, and
the first ring portion comprises an extension portion configured to extend beyond the inner ring and the orbital forming portion, and a boot assembly portion on which a boot is assembled is formed in the extension portion.
